(19) United States
(12) Patent Application Publication
(10) Pub. No.: US 2014/0337073 A1
(43) Pub. Date: Nov. 13, 2014

(54) COMPUTER-IMPLEMENTED SYSTEM AND METHOD FOR MAKING VIRTUAL SALES VISITS

(71) Applicant: JEFF MEEHAN, Chester, NJ (US)

(72) Inventor: JEFF MEEHAN, Chester, NJ (US)

(21) Appl. No.: 14/272,352

(22) Filed: May 7, 2014

Related U.S. Application Data
(60) Provisional application No. 61/820,911, filed on May 8, 2013.

(51) Int. Cl. G06Q 10/06; H04N 7/14

(52) U.S. Cl. CPC G06Q 10/06311; G06Q 10/06395; H04N 7/141
USPC 705/7.13

(57) ABSTRACT

A computer-implemented method for managing virtual sales visits is provided. In exemplary embodiments, the method may comprise, at a computing device having one or more processors and memory storing one or more programs for execution by the one or more processors, scheduling a video sales call with a remote user; receiving a confirmation of the video sales call from the remote user; sending materials to the remote user; tracking and confirming that materials have been received by the remote user; executing the video sales call with the remote user; terminating the video sales call and generating a reminder to follow-up with the remote user after a predetermined time; transmitting a follow up message to the remote user; tracking and confirming that the materials have been received from the remote user within a predetermined time after the call; recording and storing a record of expenses associated with the video sales call; and receiving an indication that the video sales call is complete.

### CROSS-REFERENCE TO RELATED APPLICATIONS

The present application claims priority to U.S. Provisional Patent Application Ser. No. 61/820,911 entitled “Computer-Implemented System and Method for Making Virtual Sales Visits,” filed May 8, 2013, the disclosure of which is incorporated herein by reference in its entirety.

### BACKGROUND

1. Field of the Invention

Embodiments of the present invention are generally related to computer-implemented systems and methods for making virtual sales visits. More specifically, embodiments of the present invention relate to computer-implemented systems and methods for making virtual sales visits by using a presentation device and a web interface.

2. Description of Related Art

Pharmaceutical sales and marketing are ever evolving, as the industry is faced with challenges that include changes to the healthcare system, budget cutbacks, and physicians unable or unwilling to participate in the traditional sales call. Research has shown that 43% of all Pharmaceutical-sales rep visits end without seeing the physician. Many offices, about 1 in 4, are considered “no-see” offices, and since 2008, the number of doctors willing to see a rep has declined by about 20%.

The refusal of healthcare providers, or the like, to see sales representatives, participate in sales calls, and/or receive sales information may prevent the healthcare providers from receiving information regarding advances in treatment for various medical conditions. For example, a pharmaceutical sales representative may possess information related to advances in treating a particular disease and/or medical condition with administration/prescription of a particular drug and/or the like. By refusing to meet or interact with sales reps, healthcare providers may create a barrier to healthcare information transfer, which may prevent doctors from administering/prescribing the most effective treatments for medical conditions. As such, those seeking medical assistance may be prevented from receiving the most effective treatments available. If the healthcare providers do not receive information related to the benefits of administering and/or prescribing a specific medication, and/or the like, the medication will not be administered and/or prescribed to those that may benefit from it.

Thus, there is a need to reduce and/or eliminate barriers to healthcare information transfer. The current system of scheduling sales calls and visits is not completely effective and can be improved by facilitating effective treatment information transfer “no show” offices, or the like.

### SUMMARY

Embodiments of the present invention are generally related to computer-implemented systems and methods for making virtual sales visits. In exemplary embodiments, a computer-implemented method for making virtual sales visits may comprise: at a computer having one or more processors and memory storing one or more programs for execution by the one or more processors: scheduling a video sales call with a remote user; receiving a confirmation of the video sales call from the remote user; sending materials to the remote user; tracking and confirming that materials have been received by the remote user; executing the video sales call with the remote user; terminating the video sales call and generating a reminder to follow-up with the remote user after a predetermined time; transmitting a follow up message to the remote user; tracking and confirming that the materials have been received from the remote user within a predetermined time after the call; recording and storing a record of expenses associated with the video sales call; and receiving an indication that the video sales call is complete.

In another embodiment of the present disclosure, a computer-implemented method for making virtual sales visits may comprise: at a computer having one or more processors and memory storing one or more programs for execution by the one or more processors: scheduling a video sales call with a remote user; receiving a confirmation of the video sales call from the remote user; sending materials to the remote user; tracking and confirming that materials have been received by the remote user; executing the video sales call with the remote user; terminating the video sales call and generating a reminder to follow-up with the remote user after a predetermined time; transmitting a follow up message to the remote user; tracking and confirming that the materials have been received from the remote user within a predetermined time after the call; recording and storing a record of expenses associated with the video sales call and generating an alert if the expenses exceed a predetermined threshold; recording and storing all interactions between the computer the remote user; and receiving an indication that the video sales call is complete.

In yet another embodiment of the present disclosure, a system for managing virtual sales visits is provided that may comprise a computer having one or more processors and memory storing one or more programs for execution by the one or more processors, the computer adapted to: schedule a video sales call with a remote user; receive a confirmation of the video sales call from the remote user; send materials to the remote user; track and confirming that materials have been received by the remote user; execute the video sales call with the remote user; terminate the video sales call and generating a reminder to follow-up with the remote user after a predetermined time; transmit a follow up message to the remote user; track and confirming that the materials have been received from the remote user within a predetermined time after the call; recording.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of a system for making virtual sales visits in accordance with embodiments of the present disclosure;

FIG. 2 depicts a block diagram of a general computer system, which is capable of being used in connection with the system depicted in FIG. 1, in accordance with embodiments of the present disclosure;

FIG. 3 depicts an exemplary kit capable of being used with the system depicted in FIG. 1, in accordance with embodiments of the present disclosure;

FIG. 4 depicts a flow diagram illustrating an exemplary method for setting up a system in accordance with embodiments of the present disclosure;

FIG. 5 depicts a flow diagram illustrating an exemplary method for training users in accordance with embodiments of the present disclosure;

FIG. 6 depicts a flow diagram illustrating an exemplary method for executing a system in accordance with embodiments of the present disclosure;

FIG. 7 depicts a flow diagram illustrating an exemplary method for executing a system in accordance with embodiments of the present disclosure;

FIG. 8 depicts a flow diagram illustrating an exemplary method for executing a system in accordance with embodiments of the present disclosure;

FIG. 9 depicts a flow diagram illustrating an exemplary method for executing a system in accordance with embodiments of the present disclosure;

FIG. 10 depicts a flow diagram illustrating an exemplary method for executing a system in accordance with embodiments of the present disclosure; and

FIG. 11 depicts a flow diagram illustrating an exemplary method for executing a system in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to computer-implemented systems and methods for making virtual sales visits. More specifically, embodiments of the present invention relate to computer-implemented systems and methods for making virtual sales visits by using a presentation device and a web interface.

Embodiments of the present invention may comprise facilitating, scheduling, and conducting live sales calls via a web-based interface, or the like. In some embodiments, the live sales calls may be conducted via a video chat, or the like, between two computers. For example, the live sales calls may be conducted by transmitting video data received by a webcam, or the like, to a computer, such as a tablet computer, desktop computer, a laptop, a mobile telephone, and/or the like. The virtual sales calls may allow a sales representative to effectively discuss the needs of a healthcare provider and their patients and how a drug, and/or the like, can address some of those needs. In some embodiments, sales representatives may be provided access to value-added programs such as samples, patient education materials, co-pay assistance cards, and/or the like.

A system in accordance with exemplary embodiments may be adapted to allow a sales representative to establish contact with one or more target offices on a list received from a database. In some embodiments, target offices on the list may be assigned to a sales rep based on the location of the target offices and the location of the sales rep and/or the like. For example, the sales rep may be assigned target offices within a predetermined distance from an address, such as a corporate address or the home address of the sales rep. In some embodiments, the system may be adapted to monitor and collect data related to quota satisfaction. For example, the system may be adapted to collect, save, and report data regarding whether each sales rep has met an individual quota, and/or the like.

In exemplary embodiments, the system may be adapted to monitor sales calls for quality assurance, and sales managers may be provided access to remotely participate in a number of calls to help with training and growth of the sales representative. The system may be adapted to allow a sales rep to schedule and coordinate a live, web-based sales call with a physician and office staff to inform them about advances in medical treatments, and/or the like. Upon completion of each call, the system may be adapted to remind a sales rep to follow-up to an office within a predetermined time frame and/or allow the sales rep to transmit a follow-up communication to continue to engage and bring value to the office.

In some embodiments, the system may be adapted to provide an interface and allow a manager, or the like, to coach and train sales reps registered with the system. A manager and/or the like may be provided with access to sales calls amdn may be allowed and/or required to listen/participate in some of the live sales calls to ensure quality and compliance. In some embodiments, a third party client may also be provided security access to perform virtual “field visits” and/or audits of the sales presentations.

In some embodiments, Key Performance Indices (KPIs) may be collected and/or stored. In some embodiments, KPIs may comprise scheduling calls per day of targets; actual calls per day of targets, materials and/or samples sent, and/or the like. In some embodiments, the system may evaluate whether a sales rep has scheduled a predetermined number of sales calls, for example 80 sales calls. In some embodiments, the system may be adapted to evaluate whether a sales rep has made an actual number of calls per day, for example, 2 per day for a first month, 3 per day for a second month, and 5 per day for a third month. In some embodiments, the system may be adapted to monitor the amounts and/or number of individual materials or groups of materials and/or samples a sales rep has sent, and/or the like.

In some embodiments, a third party administrator may monitor performance of each sales representative via reports and/or alerts generated by the system. If there a performance issue is detected, reported, and/or alerted by the system, and a rep is not achieving the minimum KPIs, he/she may receive a corrective course of action. For example, the system may be adapted to immediately place these sales reps on a 30-day Performance Improvement Plan (PIP), or the like. In some embodiments, the system may be adapted to determine if performance does not improve following the 30-day period. If the system determines performance has not improved following the 30-day period, and a formal evaluation, the system may be adapted to terminate the employment of the sales rep and replace the sales rep with a trained replacement selected by an administrator. In some embodiments, the system may be adapted to receive job applicant information and credentials and present that to an administrator for approval in the event a sales rep is terminated or an additional position is created

In some embodiments, in the event that any healthcare provider (HCP) provides negative feedback, the system may be adapted to notify a medication provider immediately, and the sales representative causing the negative feedback may receive a warning and placed on a PIP, for example, a 30-day PIP. In exemplary embodiments, if the system receives If another complaint is received during the 30-day period, a formal evaluation may be conducted via the system and, if deemed appropriate, the representative may be terminated and replaced with a qualified, trained individual.

In some embodiments, in the event that a compliance issue arises, the system may be adapted to instruct and/or facilitate compliance by the administrator to a third party protocol and/or the like. In some embodiments, the system may be adapted to form a list of targets based on databases of providers, or the like. In some embodiments, the system may be adapted to allow providers to be added over time.

In exemplary embodiments, a system for making virtual sales visits may comprise a video enabled computer, a tablet computer, a power cable for the tablet computer, a wireless “hotspot”, a case, and/or the like. In exemplary embodiments, instead of a tablet computer, any type of computer consistent with the present disclosure may be used. For example, instead of a tablet computer a computer may be included in the system that may comprise a personal computer, a portable computer, a handheld computer, a cellular phone, a smartphone, a mobile phone, a mobile communications device, a laptop computer, a netbook, an Internet appliance, a Personal Data Assistant (PDA), and/or the like. In some embodiments, a status of the wear and tear of the system components may be maintained by the system, and replacement components may be ordered, automatically in some embodiments, when the wear and tear level of the component passes a predetermined threshold or the age of the component is greater than a predetermined time period, for example, three years. The status of wear and tear of the system components and the replacement of components may be handled by an administrator, and/or the like.

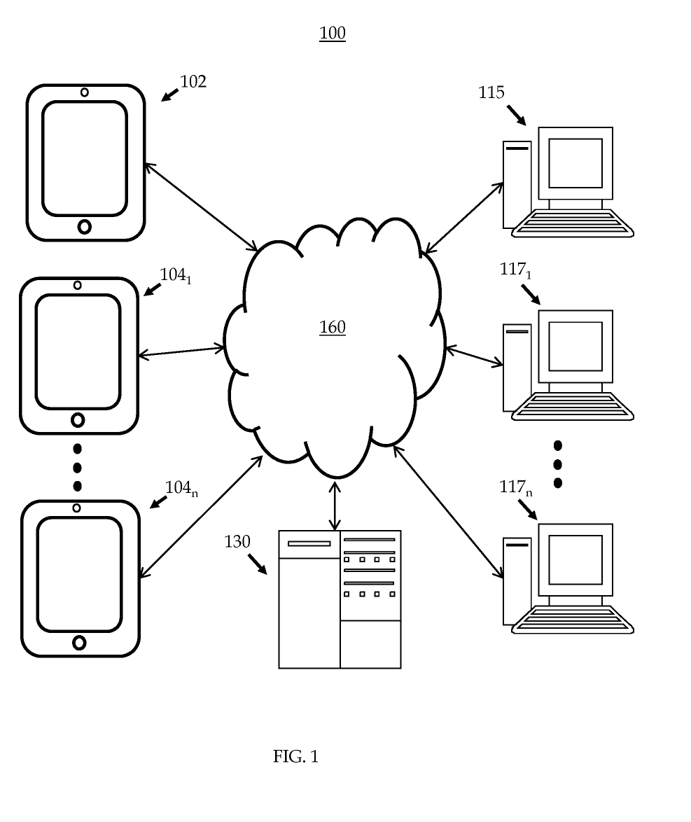

FIG. 1 depicts a system-level network diagram of a system 100 for making virtual sales visits in accordance with embodiments of the present disclosure. The system 100 generally comprises at least a first presentation device 102, generally in communication with a sales user device 115 and/or a server 130 via a network 160. In some embodiments, the system 100 may comprise secondary presentation devices 104₁ and 104ₙ and/or secondary sales user devices 117₁ and 117ₙ. The presentation devices 102, and 104ₙ and/or sales user devices 115, 117₁, and 117ₙ may be in communication with the host server 130, generally through the network 160.

Methods in accordance with embodiments of the present disclosure may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 (“Wi-Fi”) protocol, cellular data protocol (e.g., EDGE, CDMA, TDMA, GSM, LTE), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

Although FIG. 1 depicts two secondary presentation devices 104₁ and 104ₙ, it should be appreciated that “n” represents any number of presentation devices feasible in accordance with embodiments of the present disclosure. For ease of reference, as used herein, the term “presentation device” may refer to any one or all of the presentation devices, 105, 104₁, and 104ₙ within the system 100. That is, in certain embodiments, multiple presentation devices may perform the same or similar functions. For ease, one presentation device 102 will be referred to herein, however in exemplary embodiments, more than one presentation device 102 may be included in the system 100.

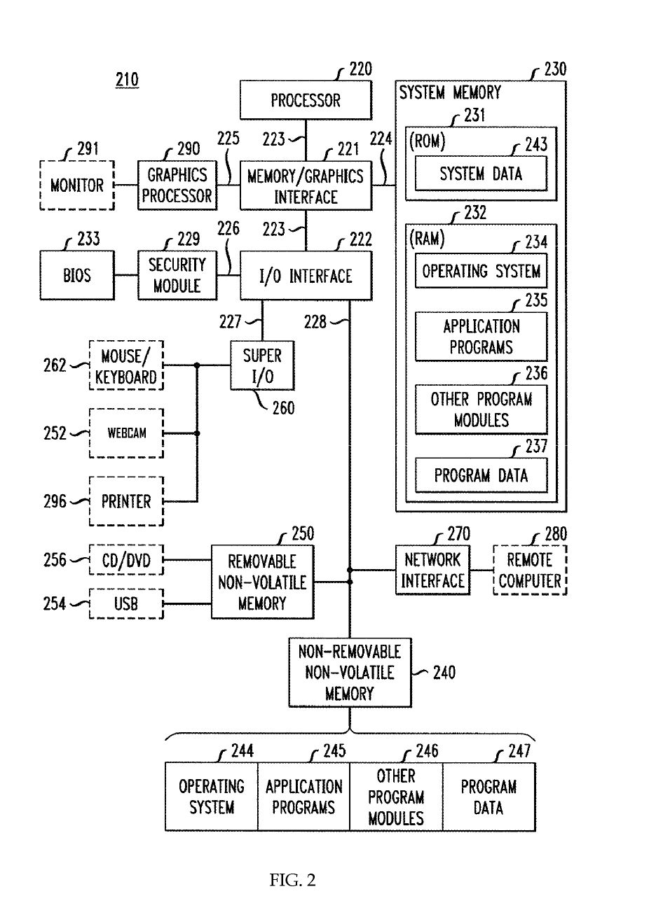

As used herein, the term “computer” may generally refer to any device that is capable of processing a signal or other information. Examples of computers include, without limitation, a personal computer, a tablet computer, a portable computer, a handheld computer, a cellular phone, a smart phone, a laptop computer, a netbook, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer, as discussed below with respect to FIG. 2. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

As used herein, the term “administrator” may refer to an entity or individual capable of administering a system in accordance with the present disclosure, or a computer or computers adapted to be operated by an administrator. An administrator may have one or more clients. The administrator may administer a system in accordance with the present disclosure for a client. For example, if a client is a manufacture or a product, the client may commission the administrator to administer a system in accordance with the present disclosure for the client, for example, by employing a sales force and operating a Virtual Representative System, described below.

In some embodiments, an “administrator” may comprise a user with access to the systems and methods in accordance with embodiments of the present invention. For example, an administrator may comprise a provider of electronic data interchange (EDI) solutions that facilitate the critical connection between doctors and payers, or the like. An administrator may provide services for electronic claim submission, eligibility verification, patient statements, electronic remittance advice, and targeted educational programs, and “all-payer” EDI solutions. In another example, an administrator may comprise a medical communications agency specializing in scientific, logistical, and tactical development and implementation of programs and events for pharmaceutical, diagnostic, and medical device clients, or the like. An administrator may collect and/or host data regarding medical transactions, providers, and patients collected over a period of time.

As used herein, the term “client” may refer to an entity that sells products and/or services, and/or one or more computers adapted to be operated by the client. As used herein, the term “customer” may refer to an individual, group, and/or entity that is interested in purchasing, renting, or discussing a product and/or service offered by the client, and/or one or more computers adapted to be operated by a “customer.”

The presentation device 102 and/or the sales user device 115 may generally comprise a communications device, such as a computer. For example, the presentation device 102 may comprise a tablet computer and the sales user device 115 may comprise a personal computer. In a basic exemplary embodiment, within the system 100, the presentation device 102 may be adapted to transmit data to and from a host server 130. The host server 130 and/or the sales user device 115 may host an accessible data portal (e.g., a website or the like). The accessible data portal, which may be accessible to the presentation device 102, may facilitate communication between the presentation device 102 through the network 160. The accessible data portal may comprise any number of security measures to provide a reasonably secure system, suitable for embodiments of the present disclosure. The accessible data portal may further comprise a graphical user interface (GUI) through which a presentation device 102 may access and/or receive content from the server 130 and/or the sales user device 115.

The system may also comprise additional servers (not shown) and/or sales user devices 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one server 130, and/or additional servers within the system 100. That is, in certain embodiments, multiple servers may perform the same or similar functions.

The at least one of the server 130, presentation device 102, and the sales user device 115 may comprise a database or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a client operating a first presentation device 102, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or presentation devices may comprise a general purpose computer, for example, as shown in the form of a computer 210 depicted in FIG. 2.

FIG. 2 depicts a block diagram of a general computer system, which is capable of being used in connection with the system depicted in FIG. 1, in accordance with embodiments of the present disclosure. As appreciated by embodiments of the present disclosure, tablet computers, such as Apple's iPad® and other mobile devices, such as mobile telephones, netbooks, or the like, may be utilized instead a general computer 210 for embodiments of the present disclosure. However, it is also appreciated there is a significant similarity in core components between a tablet computer, a mobile device, and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up. In some embodiments, a security module 229 may be incorporated to manage metering, billing, and enforcement of policies. The security module 229 may comprise any known security technology suitable for embodiments disclosed herein.

A super input/output chip 260 may be used to connect to a number of peripherals, such as a webcam 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace. In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A presentation device may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present disclosure, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure. It is understood by embodiments of the present disclosure that a computer, such as the one depicted in FIG. 2, may be connected to a computer network or system. A computer network may include the Internet, a global computer network, an internal computer network, dedicated server networks, or the like.

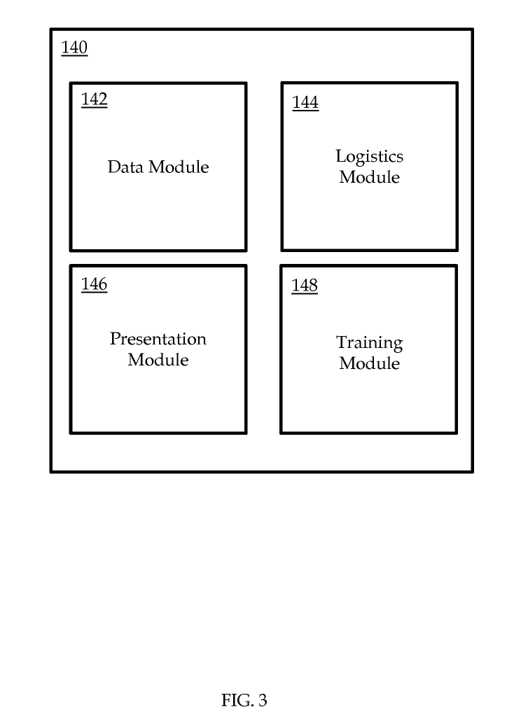

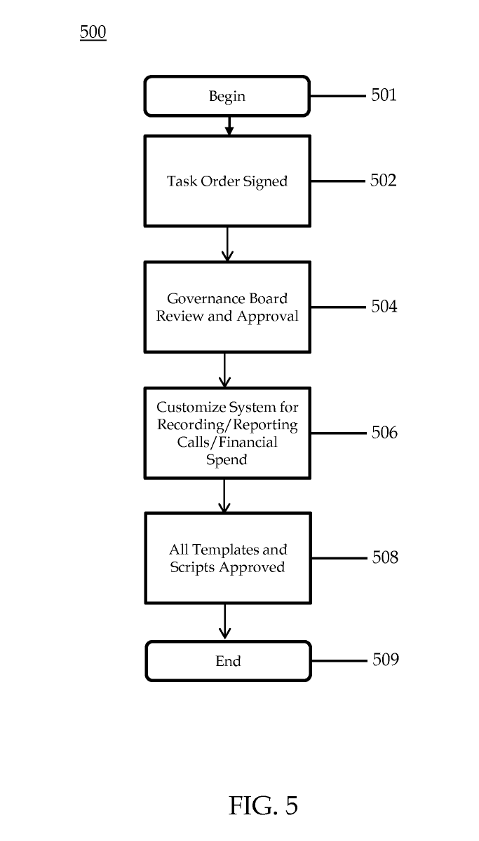

FIG. 3 depicts a block diagram of a Virtual Rep System 140 in accordance with embodiments of the present disclosure. The Virtual Rep System 140 may generally comprise computer executable software and/or instructions configured to perform the functionality of the systems and methods disclosed herein. The Virtual Rep System 140 may comprise a data module 142, a logistics module 144, a presentation module 146, and/or a training module 148. The Virtual Rep System 140 may be completely stored on at least one of a presentation device 102, a sales user device 115, and/or a server 130. The Virtual Rep 140 may also be partially stored on more than one device. For example, each individual module 142, 144, 146, and 148 may be stored on a different device. In exemplary embodiments, the Virtual Rep System 140 may be configured to facilitate live sales calls between sales representatives and customers and/or potential customers via a web-based interface to discuss their needs. The Virtual Rep System 140 may comprise a single software package, or may comprise more than one software package. For example, each module of the Virtual Rep System 140 may comprise a separate software package. In addition, the Virtual Rep System 140 may further comprise additional materials, such as patient education materials, co-pay assistance information, and/or the like. The Virtual Rep System 140 and the functionality of each of the modules are discussed in more detail below with respect to the methods described in FIGS. 5-7.

The Virtual Rep System 140 may be adapted for use by one or more sales representatives and/or sales teams. A sales team may comprise a dedicated team of individuals trained to use the Virtual Rep System 140. The sales team may be employees of the administrator of the Virtual Rep System 140 or of a client of the administrator. In some embodiments, the sales team may partially comprise employees of the administrator of the Virtual Rep System 140 and the client of the administrator. In some embodiments, the administrator of the virtual Rep System 140 and the client of the administrator may comprise a single entity, individual, and/or team. In other embodiments, the administrator and the client may comprise separate entities. For example, the administrator may comprise a software company responsible for developing and maintaining the system 140, hiring a salesperson and/or sales team capable of implementing the system, and/or training a salesperson and/or sales team to use the system. The client may comprise an entity that sells products and/or services. For example, the client may comprise a pharmaceutical company interested in agreeing with an administrator to and maintain the system, and implement the system by hiring a salesperson and/or sales team.

During the hiring process of a sales team, the administrator and/or client may need to hire a salesperson and/or a sales team. In some embodiments, as a prerequisite for inclusion in the sales team, individuals may have to meet certain hiring criteria. For example, an individual may be required to have experience in pharmaceutical sales to be included in a sales team that is allowed access the Virtual Rep System 140. The Virtual Rep System 140 may be configured to facilitate the presentation and sale of a specific brand or product. In some embodiments, the sales team may be fully trained on the brand and optimal selling sales skills by a training team. In some embodiments, a sales representative may be an employee of an administration entity responsible for the administration of the Virtual Rep System 140. In some embodiments, the administrator may enter into an agreement with a client, such as a company that sells products and/or services, implement the Virtual Rep System 140 and facilitate the sale of the products and/or services.

In exemplary embodiments, each sales representative with access to the Virtual Rep System 140 may be assigned a sales territory that may comprise any number of sales targets consistent with the present disclosure. By way of example, a sales territory may comprise approximately 100, 250, 500 targets, or the like. The responsibilities of a sales team may include establishing contact with target customers on a list throughout each working day (Monday-Friday, 8:30 AM-5:30 PM). In exemplary embodiments, sales representatives in different time zones may work different hours. By way of example, sales representatives who target the West Coast may be responsible for making calls until a fixed time, for example, 5:30 PM PST. In some embodiments, quotas may be established before a sales representative is granted access to the Virtual Rep System 140 and these sales quotas may be monitored. Sales quota data may be captured, stored, displayed, and/or transmitted by the data module 142. In some embodiments, sales calls made by the sales team may be monitored for quality assurance, and one or more sales managers may participate in intermittent calls to help with training and growth of the sales representatives. The data module 142 may be adapted to record the audio of sales calls and select random calls or all calls to be transmitted to a supervisor or other individual responsible for quality assurance. In some embodiments, sales representatives may be provided with a quota for completed calls a day. The quota may shift depending on the length of time a sales representative has used the Virtual Rep System 140. By way of example, a sales rep may be expected to make 2.1 completed calls per day in the first month, 2.2 in the second month, 3.8 in the third month, and 4.5 in the fourth month, or the like.

In exemplary embodiments, while contacting each target customer, the sales representative may be responsible for scheduling and coordinating live, Web-based sales calls with the customer. The logistics module 144 may be adapted to facilitate the scheduling of meetings, for example, with a calendar and/or meeting invitations that may be sent out electronically or printed and sent via postal mail in a substantially automated process. The presentation module 146 may be adapted to allow a sales rep or members of a sales team to conduct a video conference with a customer via a web-based interface. In exemplary embodiments, sales reps selling specific products/services may be interested in contacting a customer or potential customer with a certain occupation or demographic having a high probability and/or propensity to purchase the specific products/services. For example, a pharmaceutical sales representative may want to coordinate with physicians and physician's office staff to inform them about the benefits of the drug the sales representative is selling, with the intent of converting the physician and/or staff into interested sales leads or customers.

Upon completion of each call with a customer, the sales rep may be responsible for a follow-up to the customer within a predetermined time frame to continue to engage and bring value to the office. The logistics module 144 may be adapted to remind the sales rep of the appropriate timeframe and may facilitate a follow-up call by reminder emails and an automated process that allows the sales rep to contact the customer by use of the system 140. By way of example, the logistics module 144 may be adapted to display a pop up to the sales representative, reminding him or her to call a particular physician, and may present an icon that, when selected, either displays contact information for the physician and/or calls the physician directly.

In some embodiments, a sales leadership team may be utilized. The sales leadership team may coach and train the sales representatives throughout use of the Virtual Rep System 140 and may be given access to listen/participate in some of the live sales calls to ensure quality and compliance. In some embodiments, a client may be granted access to perform audits of and/or attend sales calls/presentations by the administrator. In some embodiments the data module 142 may be adapted to track, display, store, and transmit key performance indicators or indices (KPIs). KPIs may include scheduling calls per day of targets (for example, 80 per day), actual calls per day of targets (for example, 2 per day month-1; 3 per day month-2; and 5 per day month-3), and materials and/or samples sent. In some embodiments, the administrator may be responsible for monitoring the performance of each sales representative. If there is a performance issue, and the rep is not achieving the minimum KPIs, he/she may immediately be placed on a 30-day Performance Improvement Plan (PIP). If performance does not improve following the 30-day period and a formal evaluation, the sales rep may be terminated and replaced. In some embodiments, in the event that any customer, for example, a healthcare provider (HCP), provides negative feedback, the administrator may notify the client immediately, and the responsible sales representative will be warned and placed on a 30-day PIP. If another complaint is received during the 30-day period, a formal evaluation will be conducted and, if deemed appropriate, the representative may be terminated and replaced. In the event that a compliance issue arises, the administrator may act in accordance with the law and in accordance with protocols established by the client.

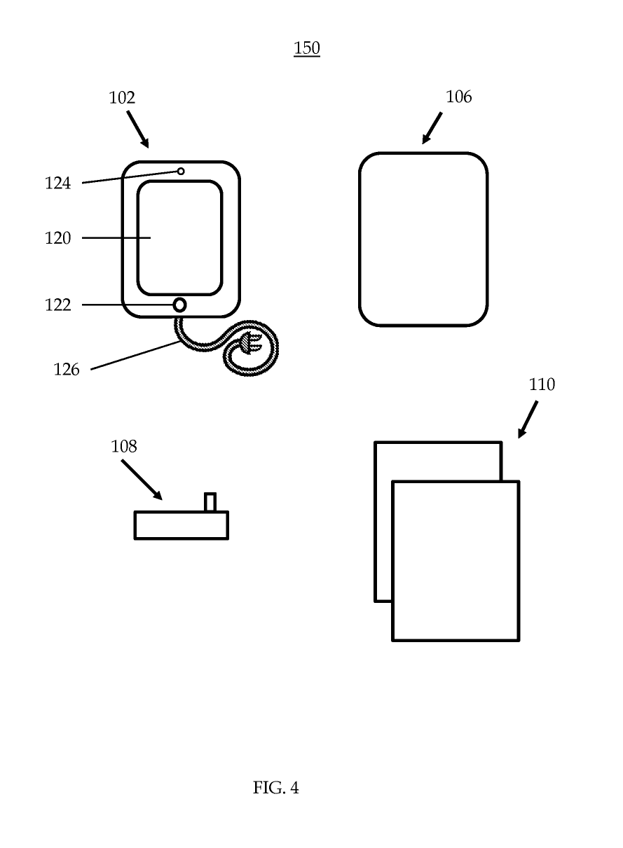

In exemplary embodiments, the administrator and/or the client may identify certain target customers. The administrator and/or client may initially target a selected number of targets. For example, a sales team may target approximately 1,000 non called-on, high-potential targets. These targets may be provided by the administrator and/or client and may be matched against the a database stored in the data module 142, comprising information about each target, such as a target provider's contact information. Additional providers may be added over time, depending on the success of the System 140. When a sales representative and/or sales team agrees with a customer and sets-up a sales call, the customer is then sent a kit in accordance with embodiments of the present disclosure, for example, as depicted in FIG. 4. Either the administrator and/or client may provide all equipment for use during Virtual Rep System 140. Based on the number of targets and number of sales reps, the System 140 may comprise a number of video-enabled desktop computers, tablet computers, hotspots, power cords, and cases. For example, the system 140 may comprise 2-3 video-enabled desktop computers, approximately 15-20 tablet computers, power cords, damage-resistant cases, and hotspot devices to ensure quality Internet connection for each call. In exemplary embodiments, the administrator and/or the client is responsible for maintaining all equipment. The equipment may be separated into sets and sent to a customer prior to a sales call in a kit 150.

FIG. 4 depicts an exemplary presentation kit 150 capable of being used with the system 100 depicted in FIG. 1, in accordance with embodiments of the present disclosure. The presentation kit 150 may be sent to a customer prior to a sales call. The presentation kit 150 may comprise a presentation device 102, a case 106, a hotspot 108, and/or a number of documents 110. The documents 110 may comprise a cover letter. The cover letter may comprise a letter approved by the client and/or administrator outlining all last-minute details and what is enclosed in the shipment. The documents 110 may also comprise a preregistered sign-in sheet. A preregistered sign-in sheet may comprise a listing of all preregistered attendees and at the time of the call, all attendees must sign in that they attended. The documents 110 may further comprise a technical support Frequently Asked Questions (FAQ) document that may be pre-approved by the client and/or the administrator and may list answers to common questions about the kit 150. The FAQ document may include the phone number of a representative to assist with any technical needs. The documents 110 may also comprise sales materials. Sales materials may comprise as printed detail aids, package inserts, and patient education materials, etc. The documents 110 may be shipped along with the other equipment in the kit 150 for distribution to attendees to ensure a fair and balanced presentation.

The presentation device 102 may comprise a computer, tablet computer, mobile phone, or any device adapted to function in accordance with embodiments of the present disclosure. For example, the presentation device 102 may comprise an Apple® iPad®. The presentation device 102 may comprise a display 120 adapted to display a GUI to the user and the video of a sales call. The presentation device may comprise a video capture member 124, such as a video camera and/or webcam. The input 122 may comprise any input suitable for embodiments of the present disclosure, such as a button. The power cords 126 may be adapted to supply power to and/or recharge the presentation device 102. The hotspot 108 may be a wireless hotspot adapted to provide a communication link between the presentation device 102 and a network, such as the internet. The hotspot 108 may be included to ensure connection and video quality on the sales call.

FIGS. 5-8 depict flow diagrams illustrating exemplary methods for setting up a Virtual Rep System 140, training users to use the Virtual Rep System 140, and using the Virtual Rep System 140 to make virtual sales visits in accordance with embodiments of the present disclosure. In exemplary embodiments, the computer-implemented method 500 may comprise facilitating a sales call between a sales representative and a customer via a web interface. The method 500 may be carried out using the architecture and components described in the systems above, or may utilize any other type of system architecture suitable for embodiments of the present disclosure. It should further be appreciated, the steps of methods may be carried out in any order, unless otherwise explicitly specified by the steps of the exemplary method. For ease, exemplary methods represented in FIGS. 5-11 are described with reference to the presentation device 102, Virtual Rep System 140, and presentation kit 150 described above with respect to FIGS. 1-4. The methods may be carried out using other embodiments as well.

Many steps of the methods may generally be carried out by the Virtual Rep System 140. The Virtual Rep System 140 may be stored on a presentation device 102, a sales user device 115, a server 130, or any other data storage location consistent with the present disclosure. It will be appreciated that the steps of the methods may be performed exclusively on one device, such as the presentation device 102, or partially on more than one device, for example, partially on the presentation device 102, partially on the sales user device 115, and partially on the server 130. Any combination of shared computing power for performing the steps of the methods described herein consistent with the present disclosure is contemplated. For example, multiple presentation devices 102, sales user devices 115, and servers 130 may collaborate to perform the steps of methods in accordance with exemplary embodiments. Although many of the steps are described below as being performed on a presentation device 102, other elements of the system 100 or combination of elements may perform the steps as well.

In some embodiments a presentation device 102 may be operated by a healthcare provider, a sales user device 115 may be operated by a sales employee, and a server 130 may be operated by a sales administrator and/or a third party administrator. For example, the presentation device 102 may be operated by a physician or an employee at a physician's office, the sales user device 115 may be operated by a pharmaceutical sales rep, a server 130 may be operated by a supervisor of the pharmaceutical sales rep and/or may be operated by a third party, such as a manager at a pharmaceutical company 130. In some embodiments, the pharmaceutical sales rep may be employed by a company administering the systems 100, 140 described herein, and the pharmaceutical company 130 may contract with or otherwise employ the company administering the systems 100, 140 described herein to sell their products to healthcare providers.

FIG. 5 depicts a flow diagram illustrating an exemplary method 500 for setting up a system 100 in accordance with embodiments of the present disclosure. The method 500 begins at step 501. At step 502, a task order may be signed. The task order may be signed digitally. A signed task order may be received from a server 130. In exemplary embodiments, the administrator may submit a complete task order inclusive of sales project scope and billing benchmarks for signature. At step 504, in some embodiments, the administrator will work with the client to submit all necessary documentation for review and approval. For example, the necessary documentation may be submitted to a Governance Board of the client for review and approval.

At step 506, the administrator may customize the system 100 for recording, reporting calls, and/or expenses. The administrator may customize the system 100 to record and report calls and for capturing expenditures with the data module 142. In some embodiments, the data module 142 may comprise a call-capture system. The administrator may set up the call-capture system and may train each sales representative to use it. The call-capture system may allow for the recording and reporting of all sales calls, including the planned and completed virtual sales calls. It allows for the input of all spend associated with the call. Spend tracking may include shipping and food and beverage at the attendee level. In exemplary embodiments, the Virtual Rep System 140 may be adapted to comply with all state reporting policies. Reporting may also be provided in a format and frequency defined by the client and/or the administrator.

At step 508, the administrator may have all templates and scripts approved. In exemplary embodiments, the administrator may work to create all templates for e-mail communication and scripts for scheduling the sales calls, which will be submitted for approval. All documents may be reviewed and approved by the client and/or administrator before submission. The method 500 ends after step 508 at step 509 and the system may be set up.

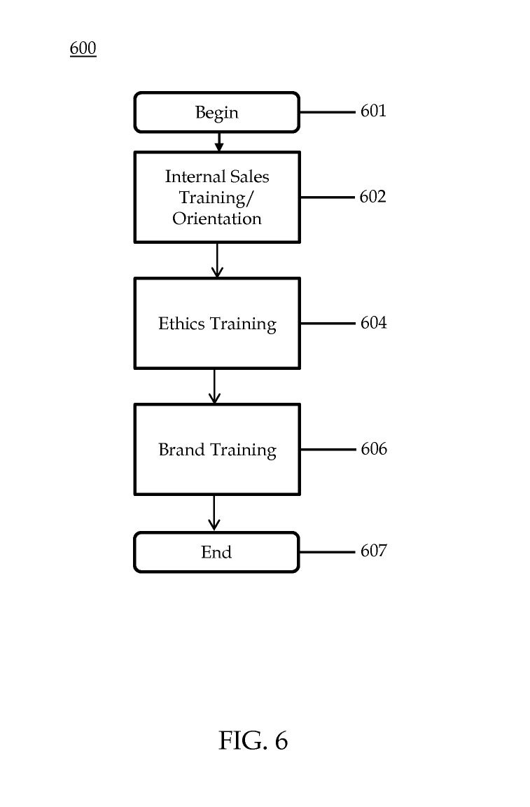

FIG. 6 depicts a flow diagram illustrating an exemplary method 600 for training users in accordance with embodiments of the present disclosure. In exemplary embodiments the training module 148 may be adapted to allow the client and/or administrator to train users, for example, sales reps. The method 600 may begin at step 601. At step 602, sales representatives may participate in internal sales training and project orientation. Sales representatives for implementing the System 100 will be hired by the client and/or administrator based on experience and criteria established by the client, administrator, and/or a sales leadership team. Sales representatives may be required to participate and successfully complete the internal sales training program, which may ensure that they are prepared to represent the team for the program and to follow required standard operating procedures (SOPs) for conducting effective virtual sales calls. In some embodiments, administrator sales representatives may participate in training established and set up by the client.

At step 604, each sales representative may be required to participate and complete integrity/ethics training and/or corporate integrity agreement (“CIA”) compliance training. In some embodiments, the training may be offered by the training module 148. In exemplary embodiments, integrity training may comprise different modules that may include ethics, compliance, state law reporting, adverse events reporting, and medical information communication. In addition CIA compliance training may be provided. At step 606, client brand training may be provided. Brand training may comprise training on the brand identities of the clients. In exemplary embodiments, a sales leadership team may work with the client to schedule CIA compliance training prior to the launch of the Virtual Rep System 140. After brand training has completed, the method 600 ends at step 607. The method 600 and any other training may be provided with quarterly sales training. The training may be brand and/or product specific and skill focused. After the system has been set-up in the method 500 and the users have been trained in step 600, the Virtual Rep System 140 may be implemented and executed. In exemplary embodiments the method of setup 500 and the method of training 600 may be performed in parallel.

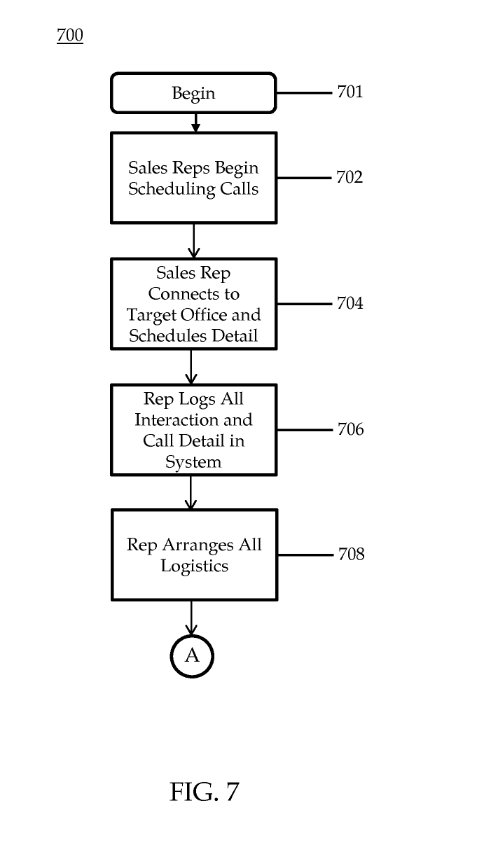

FIG. 7 depicts a flow diagram illustrating an exemplary method 700 for executing a system in accordance with embodiments of the present disclosure. At steps 702-706, sales representatives may begin engaging target offices/customers. Once all processes and protocols are agreed upon, based on the client's policies and procedures, sales representatives will begin to engage the target offices via phone and e-mail (where available) at step 702. These calls will introduce sales reps to the offices/customers, state the intent of the call, and schedule virtual sales calls with the customers of that office. In exemplary embodiments, a script for this initial call may be developed and approved by the client and/or the administrator. In exemplary embodiments, each of the method steps presented herein may be performed by at least one of an exemplary presentation device 102, an exemplary sales user device 115, and/or an exemplary server 130, as described herein.

At step 706, all interactions with target offices will be recorded in the a data capture system, and if a virtual sales call has been scheduled, the sales representative then may work to finalize all aspects of that upcoming sales call, including all logistics. In some embodiments, the sales rep and/or team may utilize a logistics module 144 to coordinate the logistics of a virtual sales call. Client and/or administrator representatives may arrange all meal logistics including food, beverage, and delivery with the logistics module 144, that may be adapted for easy ordering and delivery of food and beverage to a customer's location by looking up available restaurants/food merchants and placing orders over the internet.

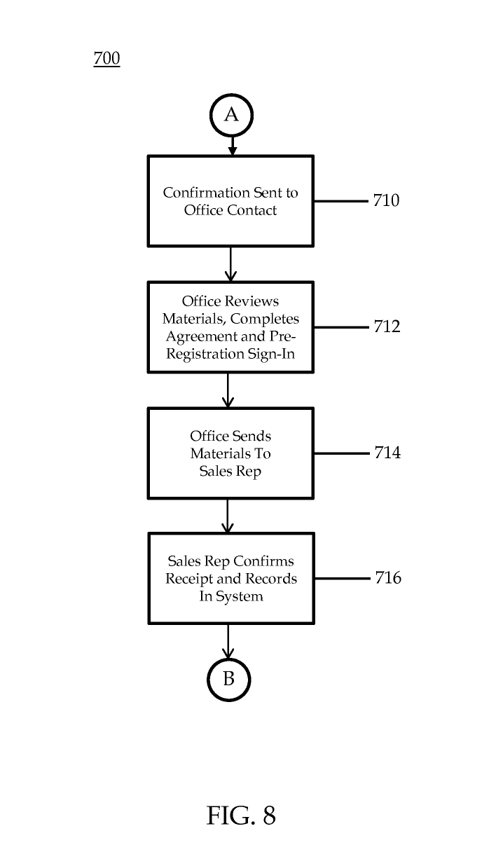

At step 708, once a virtual sales call has been scheduled, the sales rep may arrange, if necessary, all meal logistics with a local restaurant or caterer. The sales rep may be fully trained on the appropriate meal spends and may ensure compliance with all state law requirements. The sales representative may store logs all interactions with restaurant/caterer into a data capture system and/or the data module 142. A final head count for the restaurant will not be confirmed until the target office confirms attendees. The sales rep and/or sales team may send a confirmation e-mail or fax to the target customer office with all details and pre-call requirements. As indicated by the circle “A”, the method 700 may continue after step 708. After step 708, the continued method, starting at step 710, is described with respect to FIG. 8.

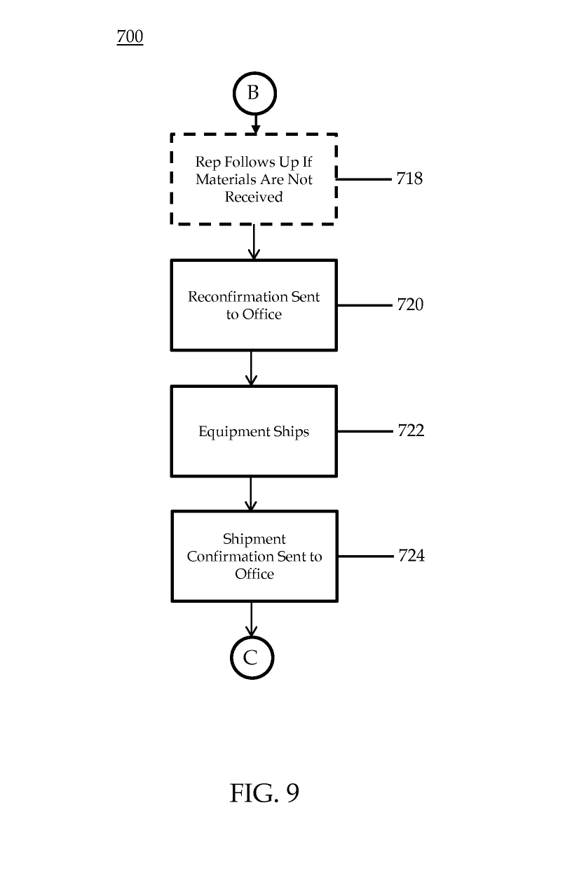

FIG. 8 depicts a flow diagram illustrating an exemplary method 700 for executing a system in accordance with embodiments of the present disclosure. At step 710, a template confirmation e-mail may be sent from the sales representative to the target customer office to confirm and outline all logistics for the upcoming sales call. Included in this confirmation are details such as: date and time of scheduled call; meal logistics, including information on the restaurant and when they will deliver the food; equipment details, such as when they can expect the shipment of materials and a brief overview of how the call is conducted. At step 710, confirmation of an office contact may be transmitted to a healthcare provider and/or the like. In some embodiments, the system 100 may be adapted to request an approval and/or acknowledgement indication from the healthcare provider after the confirmation of the office contact is sent in step 710. At steps 712-718 (see FIG. 9), the target office may review materials, complete all necessary documents, and fax or e-mail back to the representative.

In exemplary embodiments, at step 712, the physicians office may review materials via an additional computer (not shown), and/or the like. In some embodiments, pre-call requirements may be necessary to finalize the details and allow the system 100 to be utilized effectively, which may include: review and signature of a lead agreement document, which may comprise a Lead Physician Agreement. A Lead Customer/Physician Agreement may outline the scope of the program and allow the customer/physician to initial and sign that they agree to the terms, including accepting and returning all equipment. A pre-registration sign-in sheet may be required. It may be required that the office/customer preregister those who will be participating in the call, including their name, degree, and signature. The administrator may be required to ensure that offices/customers comply with all laws and regulations and those who are directly involved in patient care may be present for the call and accept a meal.

In step 712, the target office/customer may complete and sign the agreement and complete the required preregistration sign-in sheet (where meals are provided) and return them back to the sales representative. If the documents are not returned within a specified time, for example, 48 hours, the system 100 may be adapted to allow the sales representative to reach out to the office to remind them. At step 714, the office may transmit and/or send the materials to the sales rep. Once received, at step 716, the system 100 may be adapted to allow the sales representative to review the documents for completeness and accuracy and records all information into the data capture system and/or the data module 142 and confirm receipt by recording a confirmation indication via the system 100. As indicated by the circle “B”, the method 700 may continue after step 716. After step 716, the continued method, starting at step 718, is described with respect to FIG. 9.

FIG. 9 depicts a flow diagram illustrating an exemplary method 700 for executing a system 100 in accordance with embodiments of the present disclosure. At step 718, in exemplary embodiments, the system 100 may be adapted to allow a sales rep to follow up with an administrator via the system 100 and/or adapted to provide a reminder to the sales rep if the rep has not received materials within a predetermined time. A system 100 may be adapted to provide the representative contact information for a healthcare provider and/or an interface for contacting a healthcare provider. The system may be adapted to allow a representative to call to confirm the meal logistics with the restaurant, including total head count based on the preregistration and/or use the logistic module 144 to confirm the meal logistics electronically through e-mail or other electronic messaging. In some embodiments, the administrator may order only the appropriate number of meals based on the preregistration sign-in sheet and validation that all those registered are appropriate customers, for example, health-care providers (HCPs). Only those HCPs who are eligible to attend may be allowed a meal. Appropriate attendees may include physicians, NPs, PAs, RNs, and any other persons who are directly involved with the care of patients. If a non-HCP attempts to participate in a program with a meal provided, the sales representative will stop the call, apologize for any inconvenience, kindly request that only HCPs be present, and remind the office of the strict regulations that they are required to adhere to. Once the individual has vacated the area, the call may continue.

At step 720, at some specified time, for example, one week before the scheduled call, a reconfirmation e-mail or fax may be sent to the office and/or customer. The administrator may send a template reconfirmation e-mail to the office and/or customer, reminding them of the upcoming call and another review of the logistics and equipment shipping. At step 722, at some predetermined time period, for example, three (3) days before the scheduled call, the administrator may ship all equipment and materials, which may include only the materials approved by the client and/or the administrator, to the target office. In some embodiments, the administrator may ensure that all necessary materials and equipment are packed and shipped to the target office for receipt at some pre-specified time period, for example, one day prior to the call, via a mail carrier, such as FedEx®. In that shipment, the following materials may be included: a cover Letter, outlining all last-minute details and what is enclosed in the shipment; a preregistered sign-in sheet with all preregistered attendees (at the time of the call, all attendees must sign in that they attended); a technical support FAQ document that answers some common questions about the equipment and includes the phone number of a representative to assist with any technical needs; equipment and case that includes tablet computer, a wireless hotspot, and power cords, wherein the tablet computer may be programmed with the necessary application to conduct the virtual call, and all other applications are locked/blocked from use (the virtual call may be conducted using the presentation module 146); sales materials such as printed detail aids, package inserts, and patient education materials, etc. In exemplary embodiments, at least some of the items listed above will be shipped along with the equipment for distribution to attendees to ensure a fair and balanced presentation.

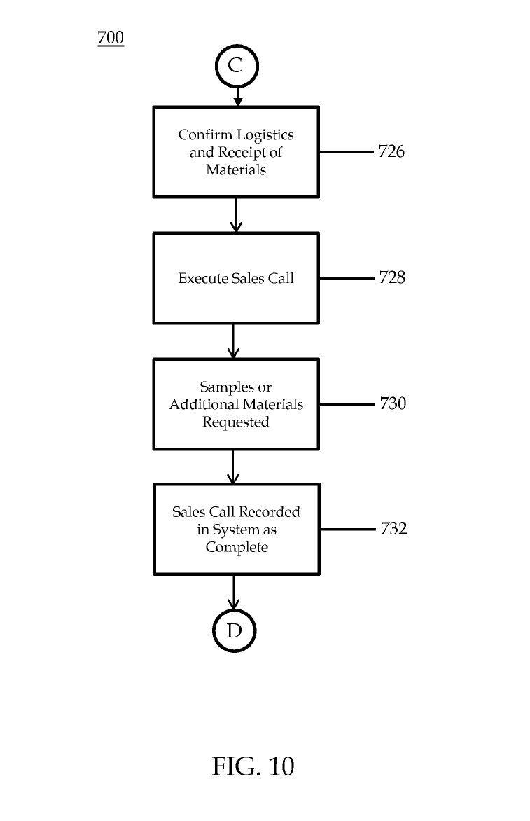

At step 724, at a specified time period, for example, two (2) days before call, a shipment confirmation e-mail is sent to the office. In preparation for the receipt of the shipment of materials and equipment, the administrator may track the shipment via FedEx® or similar carrier and send a shipment confirmation e-mail to the office 2 days prior to the call. This may alert the office of the important shipment that will arrive the next day and to offer any assistance, should there be questions. As indicated by the circle “C”, the method 700 may continue after step 724. After step 724, the continued method, starting at step 726, is described with respect to FIG. 10.

FIG. 10 depicts a flow diagram illustrating an exemplary method 700 for executing a system 100 in accordance with embodiments of the present disclosure. At step 726 at a specified time period, for example, one (1) day prior to the call, the sales representative may call the office to confirm receipt of materials and conducts a demo. In order to ensure confidence that all materials are ready for the call the next day, the sales representative may contact the office and walk them through any of the technical needs. The sales representative may conduct a demo call with the office staff to ensure equipment is operating properly. The sales representative will also confirm the time of the scheduled call and reminds the office of the meal delivery.

At steps 728-730, a sales representative executes sales call with the presentation module 142. In some embodiments, approximately 10 minutes before the scheduled time of the call, the sales representative may log into the presentation module 146 program and set up the detail, including all electronic sales materials. When the office/customer logs in, the sales representative may confirm that all audio and visual elements are working and will begin the sales call with the following requirements: recites a statement that only appropriate HCPs can be in attendance when meals are provided; using the preregistered sign-in sheet, conduct a roll call of who is in attendance, if there are those attending who did not preregister, they are asked to verbally announce who they are, including name and degree, and then they must sign-in on the provided sign-in sheet; the meeting is conducted with a doctor alone or the doctor and staff. In some embodiments, meetings may be conducted across multiple rooms/offices in the same location or multiple offices at the same time. In some embodiments, the sales calls must be conducted in accordance with compliance laws and the client's compliance rules. The call may also be conducted in accordance with the client and/or administrator's regulations. If a sample request is made by the customer, the sales rep may share data with the customer, and the administrator will complete the sample ordering. If a sample request form is required, the sales rep will ensure the office has this document to fill out and submit. If an adverse event is reported, the administrator will follow the client's protocols and training.

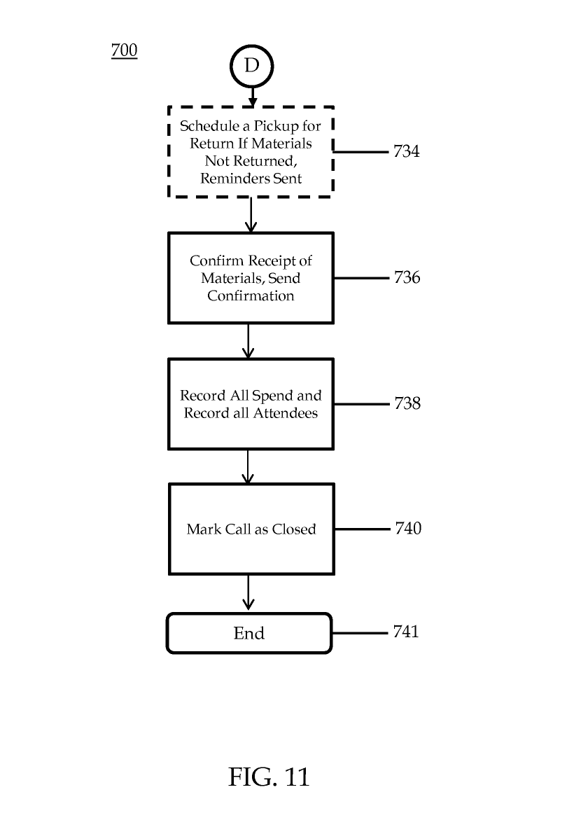

At Step 732, the sales call detail may be recorded in the system 100. All details of the call, including any sample requests, may be recorded into the system for reporting, including date and time of call, all those in attendance, a topic from a list of preapproved topics, spend capture, and any requests made during the call (e.g., samples, materials, medical information, adverse event reporting). In exemplary embodiments, all “visits” are tracked and recorded. Sample and material shipment may be coordinated through existing distribution mechanisms or rep delivered if in a covered zip code. Some clients may be provided with monthly reports on rep productivity. As indicated by the circle “D”, the method 700 may continue after step 732. After step 732, the continued method, starting at step 734, is described with respect to FIG. 11.

FIG. 11 depicts a flow diagram illustrating an exemplary method 700 for executing a system 100 in accordance with embodiments of the present disclosure. At step 734, at a specified time period, for example, one (1) day post-call, the administrator schedules a shipping company pickup to arrange for the shipment of materials back to administrator in one shipment kit. Instructions and a return label for shipment may be included in the materials received by the office/customer. One day post-call, the office/customer may pack up the equipment (using prearranged packaging), and the administrator may arranges for a shipping company pickup, for example, using the logistics module 144. In some embodiments, the administrator may confirm with the shipping company the pickup of the package. Included in this return shipment may be all equipment (case with iPad, HotSpots, and chargers) as well as the original sign-in sheet and restaurant receipt. In the event that the office/customer refuses to send back the equipment, the police would be notified and a stolen property report will be filed. At steps 736-740, the administrator may confirm receipt of materials. The administrator may confirm with the office/customer via e-mail or fax that all materials have been received. The sales representative may record all spend and attendees from the call into and ensure all documentation is included. If everything is received, the meeting will be marked as closed. The presentation device may then be received, cleaned, and prepared for re-deployment. The system may be adapted to allow a user to mark the call as closed at step 740. After the call is marked as closed in step 740, the method 700 ends at step 741. Although discussed in the pharmaceutical sales context, systems and methods consistent with the present disclosure may be used in any industry or instance where a sales professional may communicate with a customer, a professional, another party, and/or the like in a one-on-one communication.

A study has been completed in which the efficacy of the systems and methods presented herein has been supported by data. In the study, 1,829 uses of the system were completed, including 628 tele-details and 1,528 conducted with lunch. In this study, the systems and methods presented herein are equally as effective as a traditional field sales representative. The study also demonstrated that a company participating in the study increased their market share growth. Further, the study demonstrated that institutions that were previously “no-see” institutions agreed to participate in the systems and methods presented herein. A “no-see” institution is an institution wherein the employees and/or doctors employed by the institution have a policy that field sales representative will not be given appointments and will not be seen by employees of the institution. Using the methods and systems presented herein, virtual sales representatives were able to break through the “no-see” barrier in several institutions and actually schedule sales visits virtually.

In addition to the data listed above, the study also demonstrated that total prescription (TRx) growth for a specific product when using the systems and methods consistent with the present disclosure was 65% when the traditional sales rep produced TRx growth of 72%. This demonstrates that the systems and methods consistent with the present disclosure are essentially as effective as a traditional sales rep, while saving costs in other areas and increasing quality selling minutes. Further, the study demonstrated that health care professional (HCP) sales visits were 6-8 per day using the systems and methods presented herein and 8-10 with a traditional field sales rep. The average quality sales minutes per call were 18 minutes using the systems and methods of the present disclosure compared with 2 minutes for a traditional sales rep. The average quality sales minutes per day using the systems and methods of the present disclosure was 109 minutes compared with 16 minutes for a traditional sales rep. The cost per sales visit was $80 using the systems and methods presented herein and $175 using a traditional sales rep. The cost per quality sales minute was $4.50 using the systems and methods presented herein compared with $52 using a traditional sales rep.

This study also demonstrated that the systems and methods presented herein enable sales reps to increase their sales territory by approximately four times the area. In addition, the study demonstrated the systems and methods of the present disclosure enables reps to see more doctors faster, which requires less sales reps and less overhead. During the first 6 months of testing the program enabled the reps to talk to doctors an average of 18-22 minutes per visit compared with an average of 3-5 minutes with a traditional sales rep. The systems and methods consistent with the present disclosure enable reps to reduce their travel time by 75%. The systems and methods of the present disclosure also increase the span of time reps can talk to doctors (e.g.—from 9 AM-5 PM to 6 AM-1 AM).

While the foregoing is directed to embodiments of the present disclosure, other and further embodiments of the disclosure may be devised without departing from the basic scope thereof. It is also understood that various embodiments described herein may be utilized in combination with any other embodiment described, without departing from the scope contained herein. In addition, embodiments of the present disclosure are further scalable to allow for additional presentation devices and servers, as particular applications may require.

What is claimed is:

1. A method for managing virtual sales visits, the method comprising:
at a computer having one or more processors and memory storing one or more programs for execution by the one or more processors:
scheduling a video sales call with a remote user;
receiving a confirmation of the video sales call from the remote user;
sending materials to the remote user;
tracking and confirming that materials have been received by the remote user;
executing the video sales call with the remote user;
terminating the video sales call and generating a reminder to follow-up with the remote user after a predetermined time;
transmitting a follow up message to the remote user;
tracking and confirming that the materials have been received from the remote user within a predetermined time after the call;
recording and storing a record of expenses associated with the video sales call; and
receiving an indication that the video sales call is complete.

2. The method of claim 1, further comprising:
recording and storing all interactions between the computer and the remote user.

3. The method of claim 2, further comprising:
analyzing the interactions between the computer and the remote user for quality assurance.

4. The method of claim 1, wherein scheduling a video sales call comprises:
confirming a date and time of the video sales call;
confirming location of the remote user for shipment of the materials and meeting amenities; and
coordinating shipment of the materials and meeting amenities to the location.

5. The method of claim 4, wherein the meeting amenities comprise at least one of drug samples, promotional items, or food items.

6. The method of claim 1, wherein executing the video sales call comprises establishing a video chat session between the computer and the remote user and displaying the video chat session and sales information to the user in a coherent display.

7. The method of claim 1, further comprising coordinating the shipment of at least one of drug samples or promotional material to the remote user upon request.

8. The method of claim 1, wherein the materials comprise:
a tablet computer adapted to receive the video sales call; and
a mobile hotspot for communicatively coupling the tablet computer and the computer.

9. The method of claim 8, further comprising:
generating an alert if the expenses associated with the video sales call exceed a predetermined threshold.

10. A method for managing virtual sales visits, the method comprising:
at a computer having one or more processors and memory storing one or more programs for execution by the one or more processors:
scheduling a video sales call with a remote user;
receiving a confirmation of the video sales call from the remote user;
sending materials to the remote user;
tracking and confirming that materials have been received by the remote user;
executing the video sales call with the remote user;
terminating the video sales call and generating a reminder to follow-up with the remote user after a predetermined time;
transmitting a follow up message to the remote user;
tracking and confirming that the materials have been received from the remote user within a predetermined time after the call;
recording and storing a record of expenses associated with the video sales call and generating an alert if the expenses exceed a predetermined threshold;
recording and storing all interactions between the computer and the remote user; and
receiving an indication that the video sales call is complete.

11. The method of claim 10, further comprising:
analyzing the interactions between the computer and the remote user for quality assurance.

12. The method of claim 10, wherein scheduling a video sales call comprises:
confirming a date and time of the video sales call;
confirming location of the remote user for shipment of the materials and meeting amenities; and
coordinating shipment of the materials and meeting amenities to the location.

13. The method of claim 12, wherein the meeting amenities comprise at least one of drug samples, promotional items, or food items.

14. The method of claim 10, wherein executing the video sales call comprises establishing a video chat session between the computer and the remote user and displaying the video chat session and sales materials to the user in a coherent display.

15. The method of claim 10, further comprising coordinating the shipment of at least one of drug samples or promotional material to the remote user upon request.

16. The method of claim 10, wherein the materials comprise:
a tablet computer adapted to receive the video sales call; and
a mobile hotspot for communicatively coupling the tablet computer and the computer.

17. A system for managing virtual sales visits, the method comprising:
a computer having one or more processors and memory storing one or more programs for execution by the one or more processors, the computer adapted to:
schedule a video sales call with a remote user;
receive a confirmation of the video sales call from the remote user;
send materials to the remote user;
track and confirming that materials have been received by the remote user;
execute the video sales call with the remote user;
terminate the video sales call and generating a reminder to follow-up with the remote user after a predetermined time;
transmit a follow up message to the remote user;
track and confirming that the materials have been received from the remote user within a predetermined time after the call;
record and store all interactions between the computer and the remote user; and
receive an indication that the video sales call is complete.

18. The system of claim 17 wherein the remote user comprises:
a tablet computer adapted to receive the video sales call; and
a mobile hotspot for communicatively coupling the tablet computer and the computer.

19. The system of claim 17, wherein the computer is adapted to:
analyze the interactions between the computer and the remote user for quality assurance.

20. The system of claim 17, further comprising coordinating the shipment of at least one of drug samples or promotional material to the remote user upon request.
